(19) United States
(12) Patent Application Publication
(10) Pub. No.: US 2020/0382566 A1
(43) Pub. Date: Dec. 3, 2020

(54) AVOIDING ELECTRONIC CHAT MESSAGE CONFUSION USING COGNITIVE ANALYSIS

(71) Applicant: International Business Machines Corporation, Armonk, NY (US)

(72) Inventors: Randall Avery Craig, Raleigh, NC (US); John F. Kelley, Polk City, FL (US); Jennifer M. Hatfield, San Francisco, CA (US); Chris Degnen, Pleasantville, NY (US); Corey Sonier, Baton Rouge, LA (US); Tom Brugler, Fuquay Varina, NC (US)

(21) Appl. No.: 16/426,449

(22) Filed: May 30, 2019

(51) Int. Cl. H04L 29/06; H04W 4/14

(52) U.S. Cl. CPC H04L 65/403; H04W 4/14

(57) ABSTRACT

A method, system, and computer program product for placing a text message in a display. In an embodiment, the method comprises receiving, at a text messaging system, a first text message and displaying the first text message in a display area of the text messaging system; receiving, at the text messaging system, a second text message, and displaying the second text message, below the first text message, in the display area; sending a response text message from the text messaging system; and changing an order of the first, second, and response text messages for display in the display area based on an analysis of a timing of the response text message. In embodiments, the method automatically infers the message a user is replying to. In embodiments, the user interacts with the messages to indicate that the message is a reply to an earlier message.

### BACKGROUND

This invention generally relates to instant messaging, and more specifically to controlling the order in which messages appear in a display of instant messages.

Chat messaging is an online chat medium, allowing users to communicate with each other and to collaborate in real-time over a network data processing system. Chat messaging applications are very common these days. A significant portion of modern day communications takes place using these types of applications.

With chat messaging becoming an important part of both personal and business communications, functionality and usability enhancements are important to the users and providers of this type of communication tool.

### SUMMARY

Embodiments of the invention provide a method, system, and computer program product for placing a text message in a display. In an embodiment, the method comprises receiving, at a receiver text messaging system, a first text message, from a sender, and displaying the first text message in a display area of the receiver text messaging system; receiving, at the receiver text messaging system, a second text message, and displaying the second text message, below the first text message, in the display area of the receiver text messaging system; sending a response text message from the receiver text messaging system; and changing an order of the first text message, the second text message and the response text message for display in the display area of the receiver text messaging system based on an analysis of a timing of the response text message.

In embodiments, the method automatically infers the message a user is replying to. In embodiments, the user interacts with the messages to indicate that the message is a reply to an earlier message.

In an embodiment, the changing an order of the first text message, the second text message and the third text message includes re-ordering a position of the response text message to display the response text message in said display area directly below the first text message.

In an embodiment, the re-ordering a position of the response text message to display the response text message in said display area directly below the first text message includes moving the response text message from below the second text message to a position directly below the first text message in response to receiving specified input from a user of the receiver text messaging system.

In an embodiment, the changing an order of the first text message, the second text message and the response text message for display in the display area of the receiver text messaging system includes the receiver text messaging system changing a position of the response text message based on a specified time value associated with the response text message.

Embodiments of the invention address the problem of messages displaying out of order in an instant messaging display. Embodiments of the invention include automatic inference embodiments. These embodiments automatically infer the message that the user is replying to on the basis of when the user starts typing the reply message. Embodiments of the invention allow the users to interact with their message after the message has been submitted and to indicate that the message is a reply to an earlier message.

Embodiments of the invention do not rely on the user needing to engage a reply function proactively. In contrast, embodiments of the invention provide the user with the opportunity to interact with submitted messages retroactively.

### BRIEF DESCRIPTION OF THE SEVERAL VIEWS OF THE DRAWINGS

FIG. 1 depicts a representation of a network of data processing systems in which the present invention may be implemented.

FIG. 2 is a block diagram illustrating a data processing system that may be used in the implementation of embodiments of the present invention.

FIG. 3 is a block diagram illustrating components used in managing messages in accordance with an illustrative embodiment of the present invention.

FIG. 4 is a diagram illustrating an instant messaging client in accordance with an illustrative embodiment of the present invention.

FIG. 5 shows a chat window having a series of messages.

FIG. 6 is a flowchart illustrating methods for positioning messages in an instant messaging display in accordance with embodiments of the invention.

FIGS. 7A-7C are exemplary chat windows showing an automatic inference embodiment of the invention.

FIGS. 8A-8C are exemplary chat windows depicting a user interaction embodiment of the invention.

FIG. 9 depicts a cloud computing node according to an embodiment of the present invention.

FIG. 10 depicts a cloud computing environment according to an embodiment of the present invention.

FIG. 11 depicts abstraction model layers according to an embodiment of the present invention.

### DETAILED DESCRIPTION

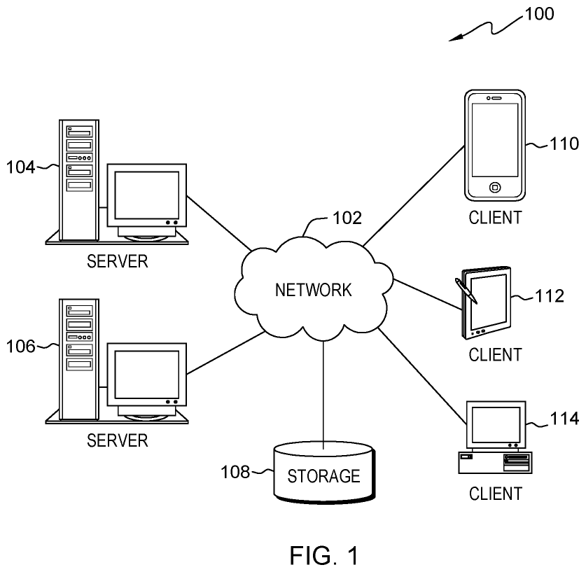

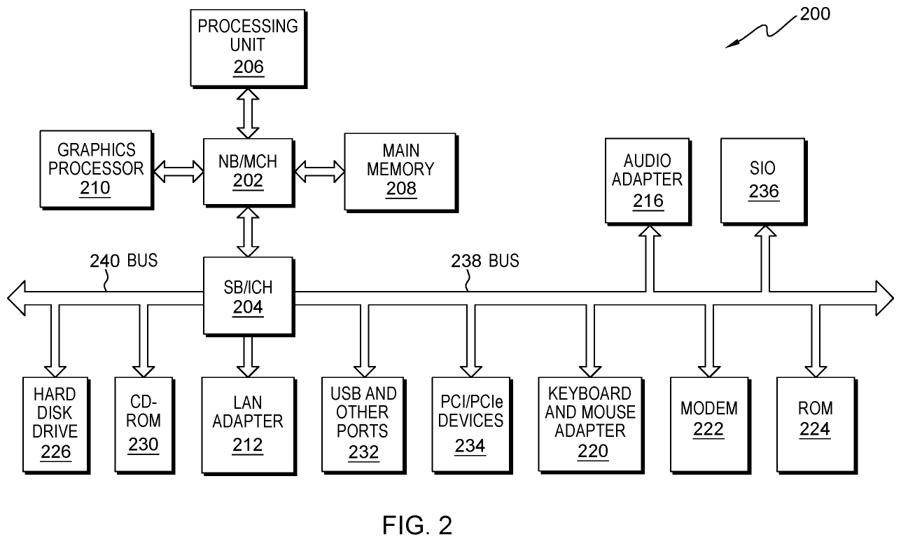

FIGS. 1 and 2 are provided as exemplary diagrams of data processing environments in which embodiments of the present invention may be implemented. It should be appreciated that FIGS. 1 and 2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system. An object-oriented programming system, may run in conjunction with the operating system and provides calls to the operating system from programs or applications executing on data processing system 200.

Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. As will be understood by those of ordinary skill in the art, the bus system may be implemented using any type of communication fabric or architecture that provides for a transfer of data between different components or devices attached to the fabric or architecture. A communications unit may include one or more devices used to transmit and receive data, such as modem 222 or LAN adapter 212 of FIG. 2. A memory may be, for example, main memory 208, ROM 224, or a cache such as found in north bridge and memory controller hub 202 in FIG. 2. The depicted examples in FIGS. 1 and 2 and above-described examples are not meant to imply architectural limitations. For example, data processing system 200 also may be a tablet computer, laptop computer, or cell phone device in addition to taking the form of a PDA.

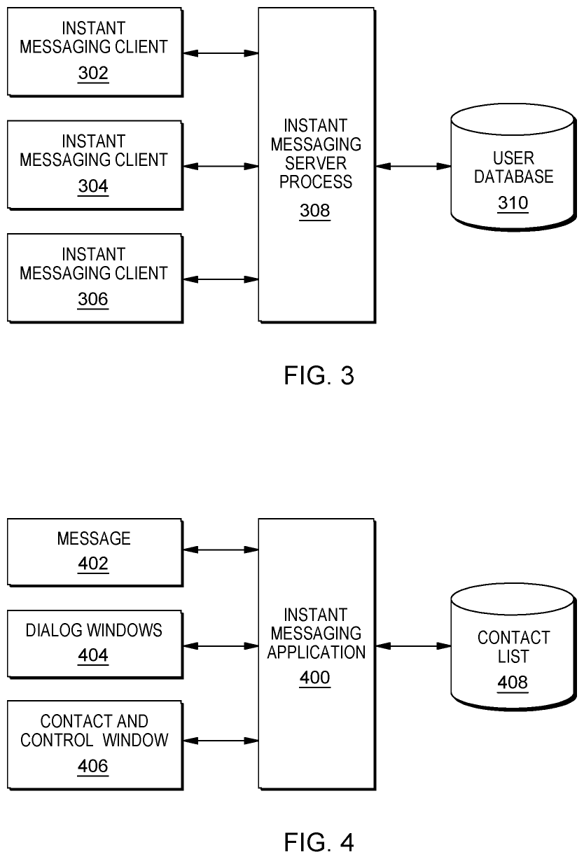

With reference to FIG. 3, a block diagram illustrating components used in an instant messaging system in accordance with a preferred embodiment of the present invention is shown. In this illustrative example, a user at instant messaging client 302 may send or exchange messages with other users at instant messaging clients 304 and 306. These instant messaging clients may be executing on a data processing system, such as data processing system 200 in FIG. 2. The exchange of messages in these examples is facilitated through instant messaging server process 308. This process allows for users to find other users within the instant messaging system as well as aid in the exchange of messages between different users.

Depending on the particular instant messaging system, instant messaging server process 308 may only be involved in providing an indication of when particular users are online and for establishing initial contacts while users contacting users already on a buddy list may contact those users directly after seeing that a particular user is online. Instant messaging server process 308 may be located on a server, such as servers 104 or 106 in FIG. 1.

In these examples, the different users registered to the instant messaging system are stored in user database 310. This user database provides information needed to search for and find other users as well as contact users when they are online.

With reference to FIG. 4, a diagram illustrating an instant messaging client is depicted in accordance with a preferred embodiment of the present invention. The components illustrated in FIG. 4 may be found in an instant messaging client, such as instant messaging clients 302, 304, or 306 in FIG. 3. These components may be implemented in a data processing system, such as data processing system 200 in FIG. 2.

In the illustrative example, instant messaging application 400 processes messages, such as message 402, received from users located on remote data processing systems. As messages are received, these messages are presented in dialog windows 404. Additionally, dialog windows 404 provide an interface for a user to input text to send messages to other users.

Contact and control window 406 is presented by instant messaging application 400 to provide the user with a list of user names, as well as other information. Contact and control window 406 also provides an interface to allow a user to set different preferences. For example, the user may set passwords required to access different names used in instant messaging sessions.

Also, a user may employ contact and control window 406 to set other preferences, such as colors and fonts used in instant messaging application 400. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 406 is stored in contact list 408 in these examples. Additional user or screen names may be added to or deleted from contact list 408. This contact list is employed in presenting the list of names within contact and control window 406.

Instant messaging has become an important part of both personal and business communications, and functionality and usability enhancements are important to the users and providers of this type of communication tool.

One drawback with chat message communications that take place in these applications is that the messages can be displayed out of order and/or asynchronously. It is a common occurrence to have a message that was meant to be in response to another message appear out of order and thereby cause confusion as to what the person who sent the former message is referring to or what the context of their message is.

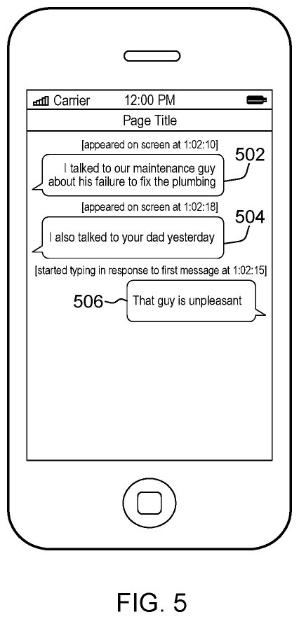

The following example, shown in FIG. 5, illustrates the problem.

With reference to FIG. 5a, Joe sends the message 502: I talked to our maintenance guy about his failure to fix the plumbing [appeared on screen at 1:02:10]. Joe also sends the message 504: I also talked to your dad yesterday [appeared on screen at 1:02:18]. Bob sends a response message 506: That guy is unpleasant” [starting typing in response to first message at 1:02:18].

Bob is responding to Joe's first text, but before Bob hits the “send” button, Joe has entered his second message. Bob's response to Joe's first text now displays after Joe's second text and it appears as though Bob is calling his own Dad unpleasant.

Embodiments of the invention address the problem of messages displaying out of order in an instant messaging display. Embodiments of the invention include automatic inference embodiments. These embodiments automatically infer the message that the user is replying to on the basis of when the user starts typing the reply message. Embodiments of the invention allow the users to interact with their message after the message has been submitted and to indicate that the message is a reply to an earlier message.

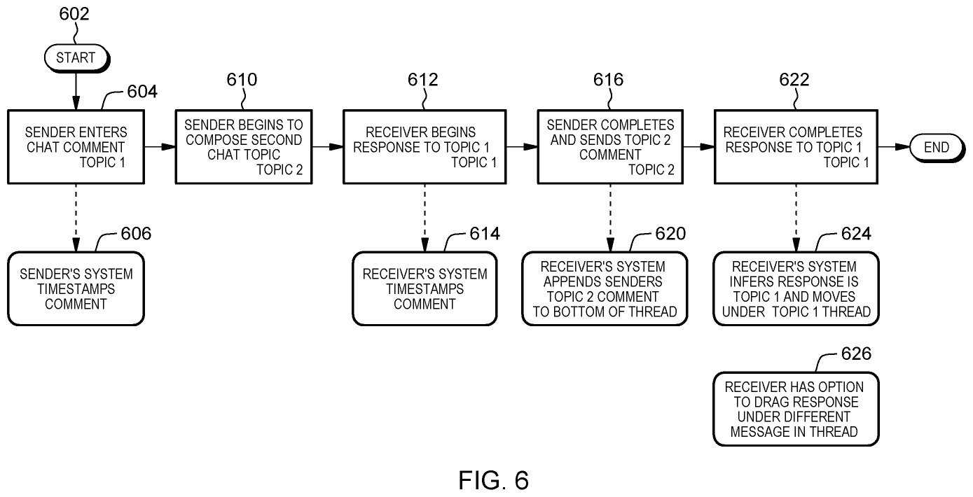

FIG. 6 is a flowchart illustrating embodiments of the invention. The process begins at 602; and at 604, a sender enters a chat comment on a first topic. The sender's system timestamps the comment, as represented at 606. At 610, the sender begins to compose a comment on a second chat topic.

At 612, the receiver begins his or her response to the chat comment on topic one; and the receiver's system timestamps the response, as represented at 614. At 616, the sender completes and sends the comment on the second chat topic; and, as represented at 620, the receiver's system appends the sender's topic two comment to the bottom of the chat thread.

At 622, the receiver completes his or her response to the sender's comment on the first chat topic. In embodiments of the invention, as represented at 624, the receiver's system infers that the receiver's response is on topic one and moves the response under the topic one thread, directly beneath the sender's comment on that topic. In embodiments of the invention, after the recipient's message is shown under the sender's second message, on chat topic two, the receiver, as represented at 626, has the option to move his or her response under a different message from the sender in the thread.

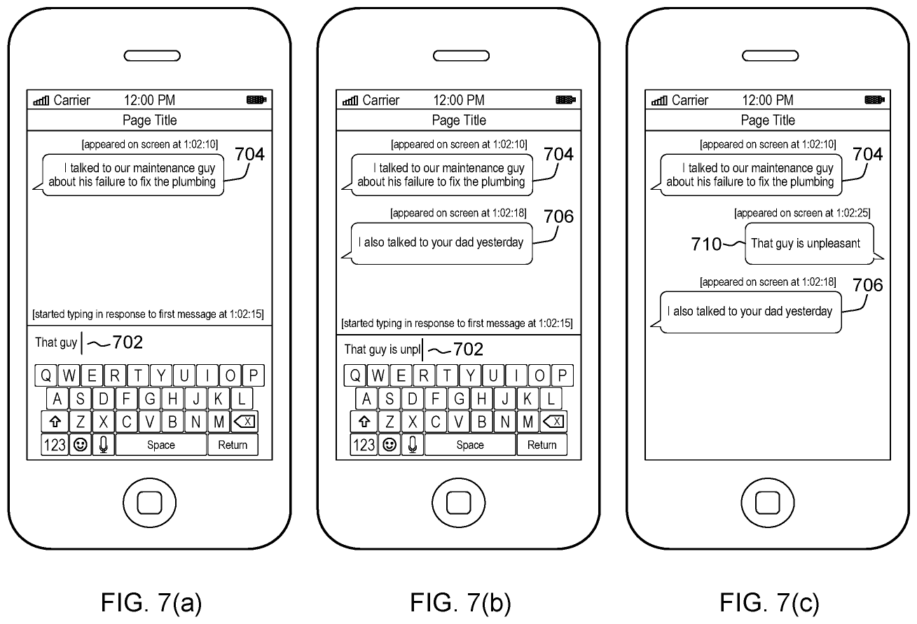

FIGS. 7A-7C illustrate an automatic inference method in accordance with embodiments of the invention.

With reference to FIG. 7A, a user is typing a reply 702 to his friend's initial text message 704. As illustrated in FIG. 7B, while the user is typing, his friend has submitted a second text message 706.

With reference to FIG. 7C, the user has now submitted his reply 702 to the first text message 704. The system has placed the reply message under the first message 704 despite the previous appearance of the friend's second message 706.

Based upon the time when the user started typing, the system inferred that the user was replying to the first text and therefore places the reply message after that text instead of the friend's second message, as shown at 710.

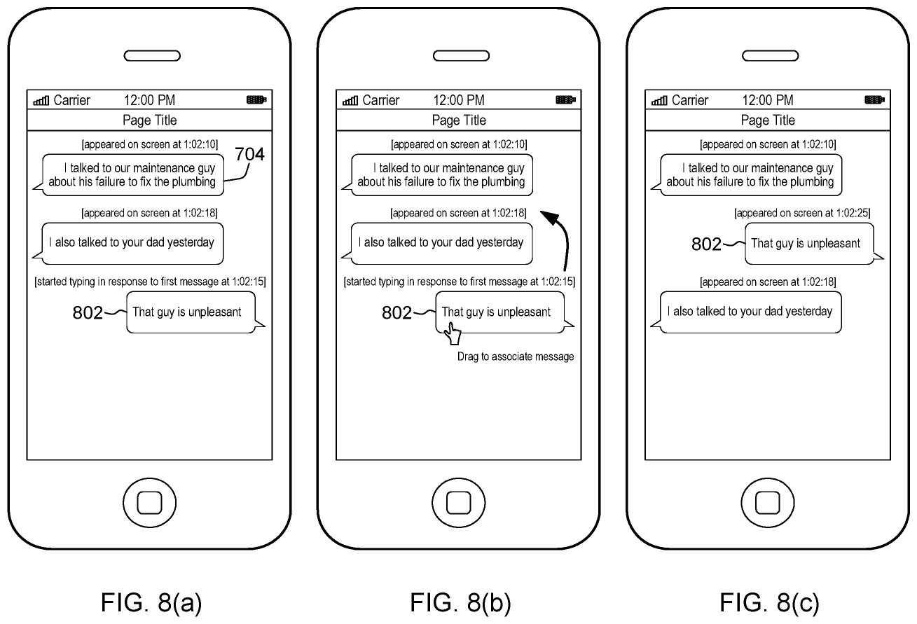

FIGS. 8A-8C illustrate an Interaction with Submitted Message method.

FIG. 8A shows the original problematic situation: the user's reply 802 has appeared out of order. With reference to FIG. 8B, in this method, the user can interact with a submitted message 802. In this example, the user, as shown at 804, drags the message 802 so that it displays in its proper place. Dragging the message is just an example of interacting with the message. There are other methods that would allow the user to accomplish the same result. For example, if a chat message application is on a personal computer, a user could be allowed to select a message and to move the message up and down using arrow keys.

As shown in FIG. 8C, the use was able to indicate that his reply was in response to the first message 804 by dragging his submitted message to the proper place.

In embodiments of the invention, chat applications may include either of the two-above-discussed methods for positioning the recipient's reply message. Also, these two processes work well together if a chat application includes both methods. For example, if the system was using the automatic inferred method, there may be situations where the inferred location for the reply message is not the location at which the recipient wants the reply message shown; and it would be beneficial if the system also allowed the post submission interaction method so that the user could place the message were the user wants the message displayed.

Embodiments of the invention are well suited for use with cloud computing which is a model of service delivery for enabling convenient, on-demand network access to a shared pool of configurable computing resources.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

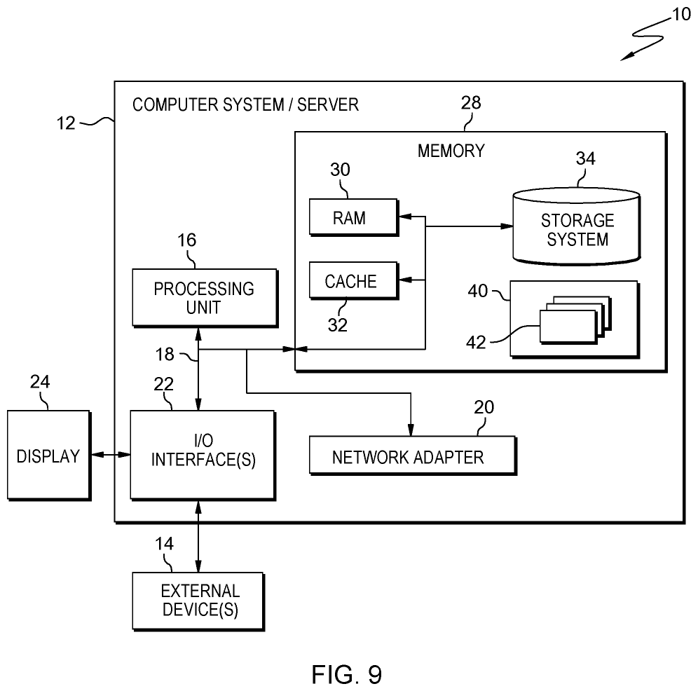

Referring now to FIG. 9, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

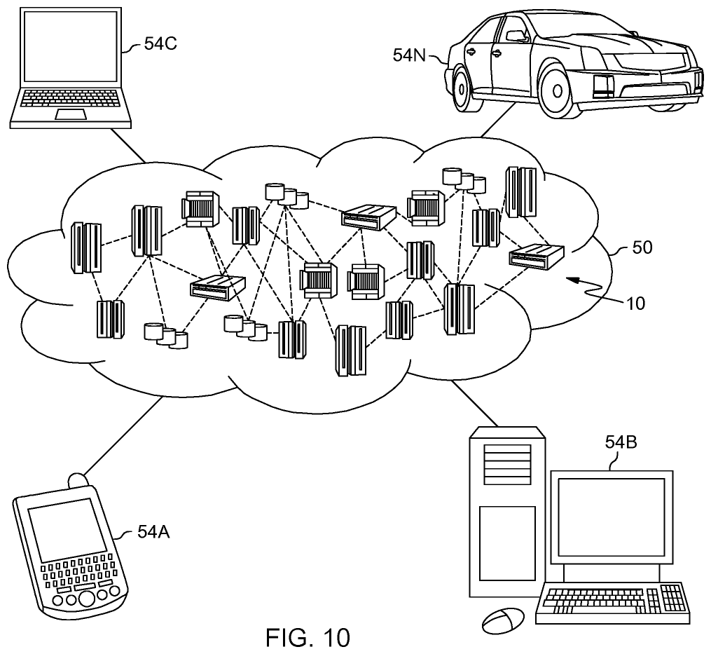

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

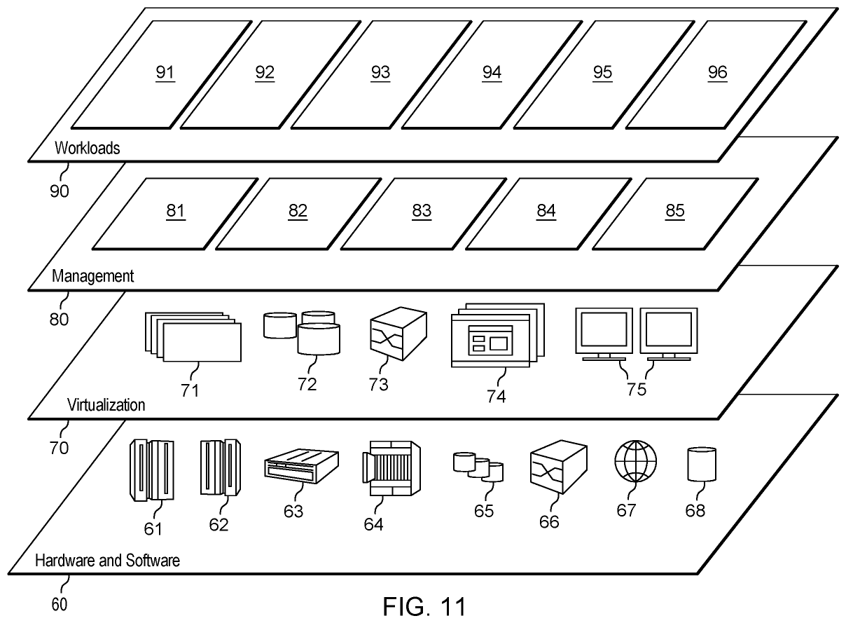

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and instant messaging 96.

Aspects of the present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A method of placing a text message in a display, comprising:
receiving, at a receiver text messaging system, a first text message, from a sender text messaging system, and displaying the first text message in a display area of the receiver text messaging system, the first text message including a time stamp from the sender text messaging system;
receiving, at the receiver text messaging system, a second text message, and displaying the second text message, below the first text message, in the display area of the receiver text messaging system;
sending a response text message from the receiver text messaging system; and
changing an order of the first text message, the second text message and the response text message for display in the display area of the receiver text messaging system based on an analysis of a timing of when the response text message is started, including determining the one of the first and second messages that the response message is replying to based on when the response message is started.

2. The method according to claim 1, wherein the changing an order of the first text message, the second text message and the response text message includes re-ordering a position of the response text message to display the response text message in said display area directly below the first text message.

3. The method according to claim 2, wherein:
the re-ordering a position of the response text message includes, after displaying the second text message in the display area, displaying the response text message in the display area of the receiver text messaging system, directly below the first text message, including
initially displaying the response text message below the second text message in the display area of the receiver text messaging system, and
moving the response text message, in the display area, from below the second text message to a position directly below the first text message.

4. The method according to claim 3, wherein the moving the response text message, in the display area, from below the second text message to a position directly below the first text message includes moving the response text message from below the second text message to a position directly below the first text message in response to receiving specified input from a user of the receiver text messaging system.

5. The method according to claim 4, wherein the receiving specified input from the user includes receiving input from the user, via a graphical user interface of the receiver text messaging system, to drag the response text message from below the second text message to the position directly below the first text message.

6. The method according to claim 1, wherein the changing an order of the first text message, the second text message and the response text message for display in the display area of the receiver text messaging system includes the receiver text messaging system changing a position of the response text message based on a specified time value associated with the response text message.

7. The method according to claim 6, wherein:
the receiver text messaging system provides a timestamp for the response text message; and
the specified time value includes the timestamp for the response text message.

8. The method according to claim 6, wherein the changing a position of the response text message based on a specified time value associated with the response text message includes the receiver text messaging system displaying the response text message in the display area of the receiver text messaging system, directly below the first text message, based on a comparison of the specified time value associated with the response text message with a defined time value associated with the second text message.

9. The method according to claim 8, wherein:
the response text message is started by a user of the receiver text messaging system at a time tₐ;
the receiving a second text message includes receiving the second text message at a time t_{b}; and
the displaying the response text message in the display area of the receiver text messaging system, directly below the first text message, based on a comparison of a specified time value associated with the response text message includes the receiver text messaging system displaying the response text message in the display area of the receiver text messaging system, directly below the first text message, when tₐ is before t_{b}.

10. The method according to claim 1, wherein the changing an order of the first text message, the second text message and the response text message for display in the display area of the receiver text messaging system includes:
the receiver text messaging system displaying the response text message in the display area of the receiver text messaging system, directly below the first text message; and
after the receiver text messaging system displaying the response text message in the display area of the receiver text messaging system, directly below the first text message, receiving input from a user of the text messaging system to move the response text message from a position directly below the first text message to another position in the display area of the text messaging system.

11. A system for placing a text message in a display, comprising:
a receiver text messaging system including
a display area for displaying text messages,
a memory, and
one or more processor units coupled to the memory,
said one or more processor units configured for:
receiving a first text message from a sender text messaging system, and displaying the first text message in the display area of the receiver text messaging system, the first text message including a time stamp from the sender text messaging system,
receiving a second text message, and displaying the second text message, below the first text message, in the display area of the receiver text messaging system,
sending a response text message from the receiver text messaging system, and
changing an order of the first text message, the second text message and the response text message for display in the display area of the receiver text messaging system based on an analysis of a timing of when the response text message is started, including determining the one of the first and second messages that the response message is replying to based on when the response message is started.

12. The system for placing a text message according to claim 11, wherein the changing an order of the first text message, the second text message and the response text message includes re-ordering a position of the response text message to display the response text message in said display area directly below the first text message.

13. The system for placing a text message according to claim 12, wherein the re-ordering a position of the response text message to display the response text message in said display area directly below the first text message includes moving the response text message from below the second text message to a position directly below the first text message in response to receiving specified input from a user of the receiver text messaging system.

14. The system for placing a text message according to claim 11, wherein the changing an order of the first text message, the second text message and the response text message for display in the display area of the receiver text messaging system includes changing a position of the response text message based on a specified time value associated with the response text message.

15. The system for placing a text message according to claim 14, wherein:
the response text message is started by a user of the receiver text messaging system at a time tₐ;
the receiving a second text message includes receiving the second text message at a time t_{b}; and
the changing a position of the response text message based on a specified time value associated with the response text message includes displaying the response text message in the display area of the receiver text messaging system, directly below the first text message, when tₐ is before t_{b}.

16. A computer program product for placing a text message in a display, the computer program product comprising a computer readable storage medium having program instructions embodied therewith, the program instructions executable by a processor to cause the processor to:
receive a first text message from a sender text messaging system, and displaying the first text message in the display area of the receiver text messaging system, the first text message including a time stamp from the sender text messaging system,
receive a second text message, and displaying the second text message, below the first text message, in the display area of the receiver text messaging system,
send a response text message from the receiver text messaging system, and
change an order of the first text message, the second text message and the response text message for display in the display area of the receiver text messaging system based on an analysis of a timing of when the response text message is started, including determining the one of the first and second messages that the response message is replying to based on when the response message is started.

17. The computer program product according to claim 16, wherein the change an order of the first text message, the second text message and the response text message includes re-ordering a position of the response text message to display the response text message in said display area directly below the first text message.

18. The computer program product according to claim 17, wherein the re-ordering a position of the response text message to display the response text message in said display area directly below the first text message includes moving the response text message from below the second text message to a position directly below the first text message in response to receiving specified input from a user of the receiver text messaging system.

19. The computer program product according to claim 16, wherein the changing an order of the first text message, the second text message and the response text message for display in the display area of the receiver text messaging system includes changing a position of the response text message based on a specified time value associated with the response text message.

20. (canceled)

21. The method according to claim 1, wherein:
the second text message is started before the response text message is started;
the second text message is completed after the response text message is started; and
the second text message is sent to the receiver text messaging system while the response text message is being prepared.
